(19) United States
(12) Patent Application Publication
(10) Pub. No.: US 2009/0210803 A1
(43) Pub. Date: Aug. 20, 2009

(54) AUTOMATICALLY MODIFYING COMMUNICATIONS IN A VIRTUAL UNIVERSE

(75) Inventors: Michele P. Brignull, Essex Junction, VT (US); Rick A. Hamilton, II, Charlottesville, VA (US); Jenny S. Li, Danbury, CT (US); Clifford A. Pickover, Yorktown Heights, NY (US); Anne R. Sand, Peyton, CO (US); James W. Seaman, Falls Church, VA (US)

Correspondence Address: IBM Endicott- DeLizio Gilliam, PLLC, c/o DeLizio Gilliam, PLLC, 15201 Mason Road Suite 1000-312, Cypress, TX, 77433, US

(73) Assignee: International Business Machines Corporation, Armonk, NY (US)

(21) Appl. No.: 12/032,203

(22) Filed: Feb. 15, 2008

(51) Int. Cl. G06F 3/048

(52) U.S. Cl. 715/757

(57) ABSTRACT

Described herein are processes and systems that automatically modify communications in a virtual universe. One of the systems described is a virtual communication modifier system. The virtual communication modifier system detects a communication intended for use in the virtual universe. The virtual communication has characteristics, such as language, format, sound quality, and text properties that can be modified automatically. The virtual communication modifier system determines whether a characteristic of the communication is different from a characteristic indicated within a user preference. If the characteristic of the communication is different from the indicated characteristic, then the virtual communication modifier system automatically modifies the communication characteristic to comport with the indicated characteristic (e.g., automatically converts the language of the communication from English to Spanish). The virtual communication modifier system then presents the modified communication.

### BACKGROUND

1. Technical Field

Embodiments of the inventive subject matter relate generally to virtual universe systems that, more particularly, automatically modify communications in a virtual universe.

2. Background Art

Virtual universe applications allow people to socialize and interact in a virtual universe. A virtual universe (“VU”) is a computer-based simulated environment intended for its residents to traverse, inhabit, and interact through the use of avatars. Many VUs are represented using 3-D graphics and landscapes, and are populated by many thousands of users, known as “residents.” Other terms for VUs include metaverses and “3D Internet.”

### SUMMARY

Described herein are processes and systems that automatically modify communications in a virtual universe. One of the systems described is a virtual communication modifier system. The virtual communication modifier system detects a communication intended for use in the virtual universe. The virtual communication has characteristics, such as language, format, sound quality, and text properties that can be modified automatically. The virtual communication modifier system determines whether a characteristic of the communication is different from a characteristic indicated within a user preference. If the characteristic of the communication is different from the indicated characteristic, then the virtual communication modifier system automatically modifies the communication characteristic to comport with the indicated characteristic (e.g., automatically converts the language of the communication from English to Spanish). The virtual communication modifier system then presents the modified communication.

### BRIEF DESCRIPTION OF THE DRAWING(S)

The present embodiments may be better understood, and numerous objects, features, and advantages made apparent to those skilled in the art by referencing the accompanying drawings.

FIG. 1 is an example illustration of automatically modifying languages of virtual communications in a virtual universe.

FIG. 2 is an illustration of an example virtual communication modifier system architecture 200.

FIG. 3 is an example flow diagram 300 illustrating automatically detecting and modifying virtual communications.

FIG. 4 is an example illustration of automatically detecting and modifying virtual communications in a virtual universe.

FIG. 5 is an illustration of an example virtual communication modifier network 500.

FIG. 6 is an illustration of an example virtual communication modifier computer system 600.

### DESCRIPTION OF ILLUSTRATIVE EMBODIMENTS

The description that follows includes exemplary systems, methods, techniques, instruction sequences and computer program products that embody techniques of embodiments. However, it is understood that the described embodiments may be practiced without these specific details. For instance, although examples refer to communications that transmit text or voice, other forms of communication may be used, like streaming media (e.g. voice or video), chats, music, etc. Various devices and communication protocols not mentioned can also be utilized, like touch based communications (e.g., Braille devices), satellite transmissions, web-cam transmissions, graphical images that represent text, cartoon depictions, etc. In other instances, well-known instruction instances, protocols, structures and techniques have not been shown in detail in order not to obfuscate the description.

### Introduction

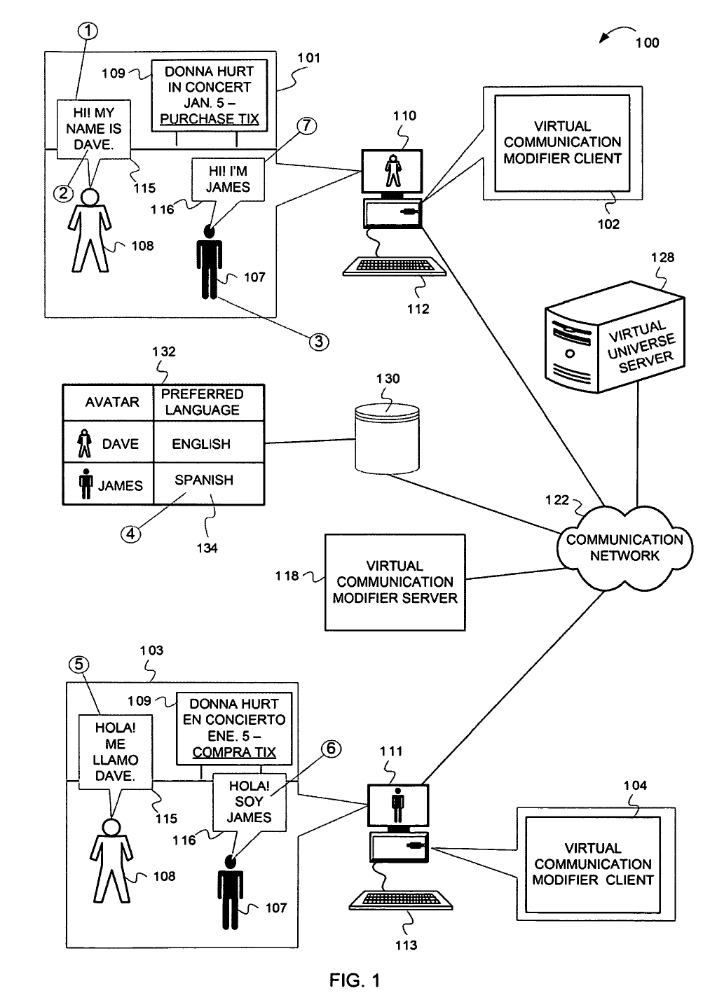

Virtual universes (“VU”s) have become increasingly popular for all types of entertainment and commerce. In a VU, a user account is represented by an avatar (e.g., a cartoon-like character) that inhabits the VU. An avatar interacts with items and other avatars in the VU. Other avatars are represented either by other user accounts or by the VU programming. Items are created by other avatars or other VU programmers to interact with avatars. Avatars and some items need to communicate information within the VU. Because avatars represent user accounts from different real-world locations or environments, the avatars may express themselves using different languages, dialects, expressions, etc. Further, items are often encountered by avatars that may have been programmed to display languages, dialects, etc. that are different from the language, dialect, etc. of the avatar that encounters the item. FIG. 1 depicts example operation of a virtual communication modifier system in a VU to automatically modify communications.

FIG. 1 is an example illustration of automatically modifying languages of virtual communications in a virtual universe. In FIG. 1, a virtual communication modifier system 100 comprises one or more various devices connected via a communication network 122. One or more computer devices 110, 111 are connected to the communication network 122 to access a virtual universe server (“VU server”) 128. The VU server 128 contains coding that the computer devices 110, 111 process to render images of virtual universe objects (e.g., avatars, background, environment, etc.) that make up one or more virtual universe rendering areas (“VU rendering areas”) 101, 103, for example, on a monitor or screen associated with the respective computer devices 110, 111. The VU server 128 accesses data stored in a database 130. The data in the database 130 is related to user accounts. The user accounts represent account information that a user utilizes to access the VU server 128. Each user account is associated with an avatar, such as avatars 108 and 107. In FIG. 1, avatar 108 is controlled by input received from computer 110. Similarly, avatar 107 is controlled by input received from computer 111. Virtual communication modifier clients 102, 104 are associated with computers 110, 111 respectively. A virtual communication modifier server 118 is connected to the communication network 122 and works in conjunction with the virtual communication modifier clients 102, 104, and other network devices like the VU server 128 and the database 130, to automatically modify communications from, in, or intended for, the VU (i.e., “virtual communications”).

The virtual communication modifier system 100, in stage “1”, detects a virtual communication, such as talk bubble 115 or text presented on item 109. For instance, a keyboard 112 on the computer device 110 can be utilized to converse within the VU rendering area 101. The conversation text appears in the talk bubble 115 within the VU rendering area 101 in English as the avatar 108 speaks. In other examples, other devices can be utilized to communicate in the VU, such as microphones, telephones, etc.

The virtual communication modifier system 100, in stage “2”, determines a language for the virtual communication. For example, the avatar 108 initiates the virtual communication 115 in English. The virtual communication modifier client 102 detects that the virtual communication 115 is in English by using one of many techniques. For instance, the virtual communication modifier client 102 could gather the contents of the talk bubble 115 and process it using language recognition software. Alternatively, the virtual communication modifier client 102, or the virtual communication modifier server 118, could read a user account associated with the avatar 108 to determine a preferred language for the user account. A database 130 could hold one or more records that store information about the user account, the avatar 108, and the preferred language of the user account. In some examples, an avatar may not be initiating a communication, but rather an inanimate item in the VU rendering area 101, like item 109. The item 109 is an example of a virtual billboard that advertises an event in the VU as displayed in the VU rendering area 101 for avatar 108. The item 109 presents the textual information on the billboard by utilizing text written in a specific language. The virtual communication modifier client 102 can determine a language for the virtual communication intended by item 109 by querying the VU server 128 for a default language for the item 109. For example, the item 109 may have a record entry in the database 130 which contains metadata and settings regarding the item 109. One of the settings, or metadata, could include the default language for the text displayed on the item 109. Further, the item 109 may communicate in ways other than textual communication, such as using audible sounds.

The virtual communication modifier system 100, in stage “3”, determines an avatar to whom the virtual communication is directed. For example, if the avatar 108 speaks the virtual communication in talk bubble 115, the virtual communication modifier client 102 could detect any indicators within the VU rendering area 101 that indicate whether the virtual communication is intended for avatar 107. For instance, the virtual communication modifier client 102 could detect a distance between the speaking avatar 108 and the nearest avatar 107. In other examples, the avatar 108 may indicate directly that the virtual communication is intended for avatar 107 (e.g., selecting the avatar 107 before speaking). In the case of the item 109, the virtual communication modifier system 100 can detect one or more avatars, such as avatars 108 and 107, that are within a specific viewing distance of the item 109. The virtual communication modifier system 100 could present the text on the item 109 as soon as one of the avatars 108 or 107 enters the viewing distance.

The virtual communication modifier system 100, in stage “4”, determines a preferred language of the avatar to whom the virtual communication is directed. For example, where the avatar 108 is communicating with avatar 107, the virtual communication modifier system 100 queries the database 130 to find a database entry 132 pertaining to avatar 107 that includes a column 134 for the preferred language of the avatar 107. The virtual communication modifier system 100 determines from the database entry 132 that avatar 107 has a preferred language of Spanish.

The virtual communication modifier system 100, in stage “5”, automatically converts the virtual communication into the preferred language for the avatar to whom the communication is directed. For example, the virtual communication modifier server 118 coverts the text within the talk bubble 115 into Spanish. Likewise, the virtual communication modifier server 118 could convert the text on the item 109 into Spanish.

In some examples the text on the item 109 is predefined, and, therefore, could be stored on a server, such as the VU server 128, in several languages. The VU server 128 could determine which one of the stored encodings matches a preferred language for either of the avatars 107 and 108. The VU server 128 can send the appropriate stored encoding for display at a client (e.g., computers 110, 111). If one of the stored encodings is not appropriate for a particular user, then the virtual communication modifier system 100 could convert or translate the text on the item 109. The virtual communication modifier system 100 could perform a pre-fetch of a default encoding and wait to transmit until it had confirmed that default encoding matched a preferred language. If the preferred language did not match the pre-fetched default, then the virtual communication modifier system 100 could look up the correct encoding. Some communications may be predefined communications from avatars and other VU users, and not just from items like item 109. For example, the talk bubbles 115, 116 may contain predefined statements, audible sounds or phrases, or text that an avatar 108, 107 uses to communicate. The predefined communications may also be stored on the VU server 128 and be fetched or pre-fetched as just described above.

The virtual communication modifier server 118 passes the converted information to the virtual communication modifier client 104 to present in the VU rendering area 103 as seen by avatar 107 via computer 111. The talk bubble 115 appears in Spanish in the VU rendering area 103 while the talk bubble 115 appears in English within the VU rendering area 101. In the case of the item 109, the virtual communication modifier system 100 also presents the text for the item 109 in Spanish to avatar 107 within the VU rendering area 103. The virtual communication modifier system 100 presents the text for the item 109 in English to avatar 108 within the VU rendering area 101.

The virtual communication modifier system 100, in stage “6”, detects a response communication from the avatar 107, such as talk bubble 116. The avatar 107 could respond utilizing the keyboard 113 to type text, or via other means, such as utilizing a microphone to speak words. The virtual communication modifier system 100 can detect audible communications utilizing spoken text recognition and conversion software. The virtual communication modifier system 100 could convert the spoken words into different formats, such as text. The virtual communication modifier system 100 then performs the process of automatically modifying the communication of talk bubble 116 by determining the preferred language for the avatar 108 and converting the communicated response from avatar 107 into the preferred language for avatar 108.

The virtual communication modifier system 100, in stage “7”, presents the response communication (e.g., talk bubble 116) in the VU rendering area 101 for avatar 108. The virtual communication modifier system 100 presents the talk bubble 116 in the VU rendering area 101 in English for avatar 108 while at the same time the virtual communication modifier system 100 presents the talk bubble 116 in Spanish for avatar 107 in the VU rendering area 103. Consequently, the virtual communication modifier system 100 provides real-time, automatic modification of VU communications, such as converting the language of VU communications. Such automatic, real-time modification enables avatars to communicate with each other independent of differences in language and format used for communicating, thus allowing effective and efficient communication in a virtual universe. Other embodiments are described in more detail further below that indicate many other ways that the virtual communication modifier system 100 can modify virtual communications automatically.

### Example Operating Environments

This section presents structural aspects of some embodiments. More specifically, this section includes discussion about virtual communication modifier system architectures.

### Example Virtual Communication Modifier System Architecture

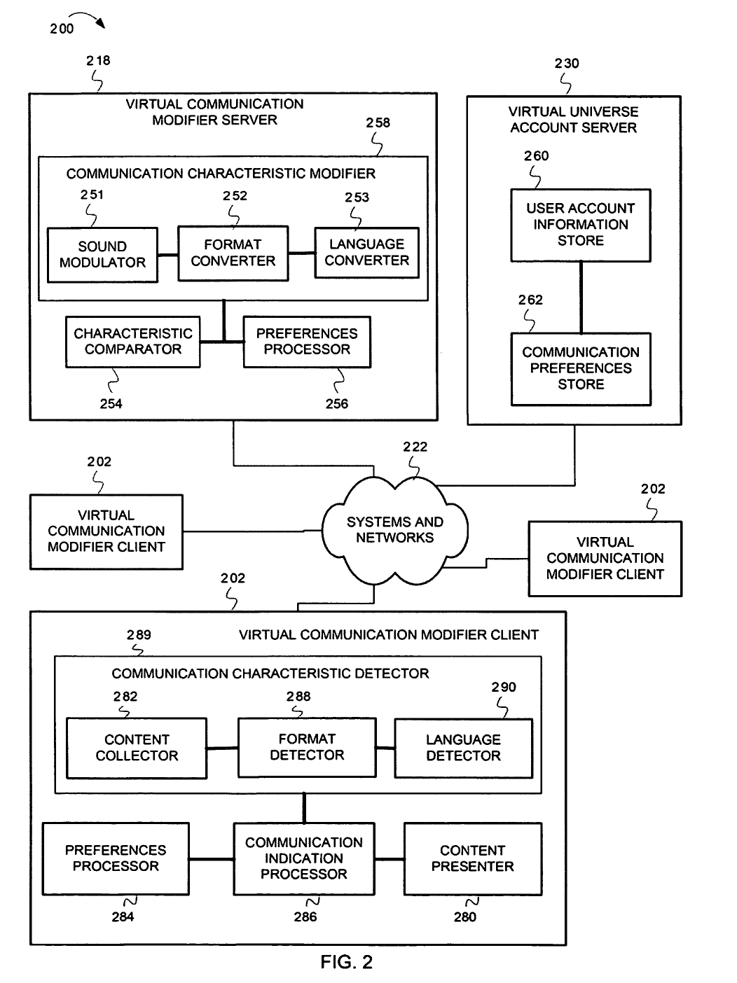

FIG. 2 is an illustration of an example virtual communication modifier system architecture 200. The virtual communication modifier system architecture 200 includes a virtual communication modifier client 202 configured to automatically collect information related to virtual communications and to present modified information associated with virtual communications. The virtual communication modifier client 202 includes a communication characteristic detector 289 configured to detect characteristics of virtual communications. The communication characteristic detector 289 may include various modules and/or devices. For example, the communication characteristic detector 289 may include a communication content collector 282 configured to detect and collect virtual communication content, such as audio, visual and textual inputs that communicate information in a virtual universe. The communication characteristic detector 289 also includes a communication format detector 288 configured to detect a format (e.g., textual, audio, etc.) of a virtual communication. The communication characteristic detector 289 also includes a communication language detector 290 configured to detect a specific language of a virtual communication. The virtual communication modifier client 202 sends collected information about virtual communications, including detected characteristics, to a virtual communication modifier server 218 via systems and networks 222. The virtual communication modifier client 202 also includes a communication content presenter 280 configured to present virtual communications received from the virtual communication modifier server 218. The virtual communication modifier client 202 also includes a preferences processor 284 configured to detect and apply user account preferences. The virtual communication modifier client 202 also includes a communication indication processor 286 configured to detect and process communication indicators that indicate to whom virtual communications are directed within a virtual universe.

The virtual communication modifier system architecture 200 also includes a virtual communication modifier server 218 configured to automatically modify virtual communication characteristics, such as languages and formats. The virtual communication modifier server 218 includes a preferences processor 256 configured to determine and process user preferences that contain data that can be used to determine whether virtual communications should be modified. The virtual communication modifier server 218 also includes a characteristic comparator 254 configured to compare a characteristic of the virtual communication to a preference indicated in a user account. The characteristic comparator 254 can determine whether the characteristic matches the user account preference. If the characteristic does not match the user account preference, then the virtual communication modifier server 218 can modify the characteristic according to the preference indicated in the user account. The virtual communication modifier server 218 also includes a communication characteristic modifier 258 configured to modify characteristics of virtual communications. The communications characteristic modifier 258 may include various modules and/or devices. For example, the communications characteristic modifier 258 includes a sound modulator 251 configured to modify the tone, speed, or other sound qualities of voice transmissions, sound effects, and other audible elements of a virtual communication. The communication characteristic modifier 258 also includes a format converter 252 configured to convert a format characteristic of a virtual communication, such as to convert a voice communication to text, or vice versa. The communication characteristic modifier 258 also includes a language converter 253 configured to convert a language characteristic of a virtual communication, such converting a virtual communication from English to Spanish.

The virtual communication modifier system architecture 200 also includes a virtual universe account server 230 configured to store user account information and preferences. The virtual universe account server 230 includes a user account information store 260 configured to store user account information. The virtual universe account server 230 also includes a communication preferences store 262 configured to store preferences regarding virtual communications.

Each component shown in the virtual communication modifier system architecture 200 is shown as a separate and distinct element. However, some functions performed by one component could be performed by other components. For example, the virtual communication modification server 218 could also detect communication indicators and communication formats. Further, the virtual communication modifier client 202 could detect and convert languages or convert communication formats. Furthermore, the components shown may all be contained in one device, but some, or all, may be included in, or performed by multiple devices on the systems and networks 222, as in the configurations shown in FIG. 2 or other configurations not shown. Furthermore, the virtual communication modifier system architecture 200 can be implemented as software, hardware, any combination thereof, or other forms of embodiments not listed.

### Example Operations

This section describes operations associated with some embodiments. In the discussion below, some flow diagrams are described with reference to the block diagrams presented above. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). Moreover, some embodiments can perform less than all the operations shown in any flow diagram.

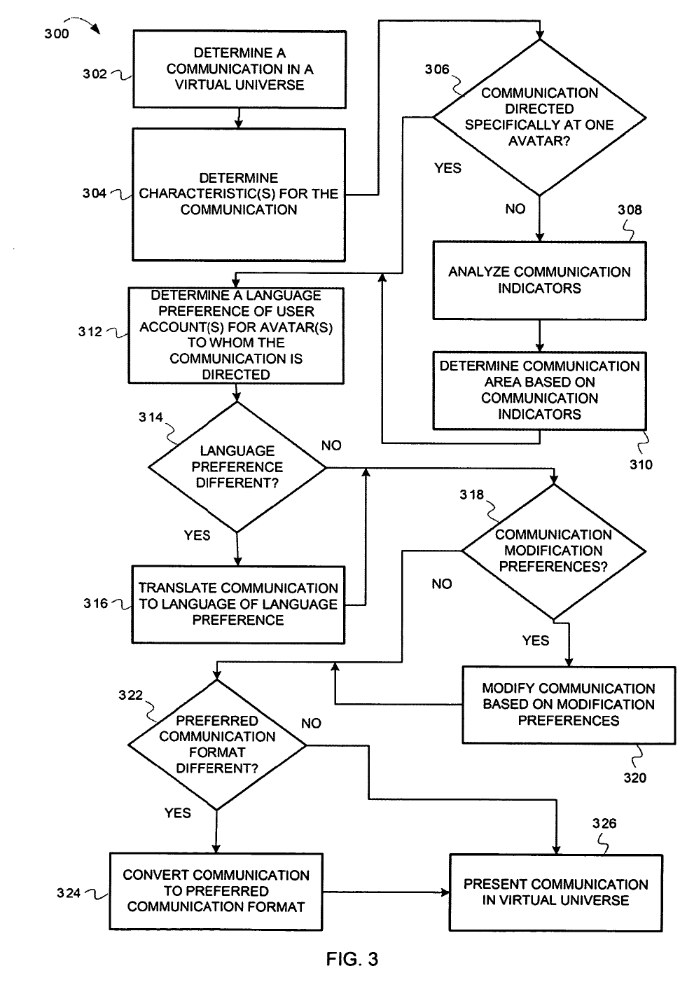

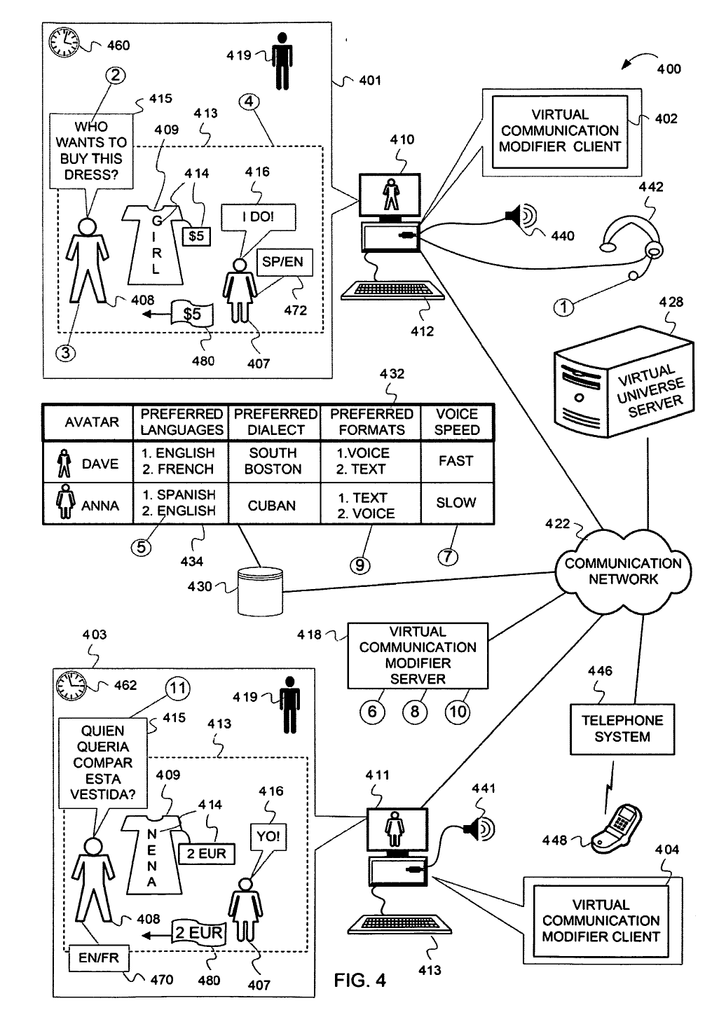

FIG. 3 is an example flow diagram illustrating automatically detecting and modifying virtual communications. FIG. 4 is a conceptual diagram that illustrates an example of automatically detecting and modifying virtual communications in a virtual universe. This description will present FIG. 3 in concert with FIG. 4.

In FIG. 3, the flow 300 begins at processing block 302, where a virtual communication modifier system determines a communication in a virtual universe (“virtual communication”). In FIG. 4 at stage “1”, a virtual communication modifier system 400 detects a virtual communication, such as talk bubble 415 or text 414 associated with item 409. In FIG. 4, a virtual communication modifier system 400 comprises one or more devices connected via a communication network 422. One or more computer devices 410, 411 are connected to the communication network 422 to access a virtual universe server (“VU server”) 428. The VU server 428 contains coding that the computer devices 410, 411 process to render images and objects within one or more virtual universe rendering areas (“VU rendering areas”) 401, 403, for example on a monitor or screen associated with the respective computer devices 410, 411. In some examples, the computers 410, 411 may also have coding that the computers 410, 411 can process to render the VU rendering areas 401, 403. The VU server 428 accesses data stored in a database 430. The data in the database 430 is related to user accounts. The user accounts represent account information that a user utilizes to access the VU server 428. Each user account is associated with an avatar, such as avatars 408 and 407. In FIG. 4, avatar 408 is controlled by input received from computer 410. Similarly, avatar 407 is controlled by input received from computer 411. Virtual communication modifier clients 402, 404 are associated with computers 410, 411 respectively. A virtual communication modifier server 418 is connected to the communication network 422 and works in conjunction with the virtual communication modifier clients 402, 404, and other network devices like the VU server 428 and the database 430, to automatically modify communications from, in, or intended for, the VU (i.e., “virtual communications”).

Referring back to stage “1”, the virtual communication modifier system 400 detects a virtual communication. For example, the avatar 408 initiates the virtual communication, as shown in talk bubble 415. The computer 410 may be connected to a headset 442 that receives voice input. The virtual communication modifier client 402 could detect the voice input and present the voice input from the speaker 440 on computer 410 or the speaker 441 on computer 411. At the same time, or alternatively, the virtual communication modifier client 402 could present a textual representation of the virtual communication within the talk bubble 415. Alternatively, or on combination with the headset 442, a keyboard 412 connected to the computer device 410 can be utilized to converse within the VU rendering area 401. Conversation text appears in the talk bubble 415 within the VU rendering area 401 as the avatar 408 converses within the VU rendering area 401. In other examples, other devices can be utilized to communicate in the VU, such as microphones, telephones, etc. The VU rendering area 401 presents one or more items, like item 409, in the VU. The item 409 is an example of a item (e.g., a virtual dress) for sale within the VU. Avatar 408 may be selling the item 409 to any avatar interested in buying the item 409. The item 409 presents the text 414 like a textual design (e.g., the word “GIRL” displayed on the front of the item 409) or the price tag (the currency symbols “$5”), which indicates a price for the item 409. The item 409 has a unique universal identifier (UUID) associated with the item. Information, such as the text 414 can be stored in the database 430 and referenced by the UUID.

The flow 300 continues at processing block 304, where the virtual communication modifier system determines one or more characteristics of the virtual communication. In FIG. 4 at stage “2”, the virtual communication modifier system 400 selects one or more characteristics of the communication, such as, but not limited to, the following: language (e.g., English, Spanish, etc.), language dialect (Mexican Spanish versus Columbian Spanish), format (e.g., text, audio, visual, electronic, etc.), voice speed (e.g., fast versus slow), voice tone (male versus female, husky versus soft, etc.), formality of language (slang versus proper grammar), text type or size (e.g., large font versus small font, serif versus sans serif, etc.) or other characteristics not listed. For example, the virtual communication modifier system 400 detects that the value of the language characteristic of the virtual communication 415 is “English”. The virtual communication modifier system 400 detects the characteristic by using one of many techniques. For instance, the virtual communication modifier client 402 could gather the contents of the talk bubble 415 and process the contents using language recognition software. Alternatively, the virtual communication modifier client 402, or the virtual communication modifier server 418, could read a user account associated with the avatar 408 to determine a preferred language for the user account. The database 430 could hold one or more records that store information about the user account, the avatar 408, and the preferred language of the user account. The virtual communication modifier client 402 could determine other characteristics, such as format, voice speed, etc. by processing the input for the virtual communication. For instance, if a user presses a key combination on the keyboard 412 to indicate that the user is about to converse on behalf of the avatar 408, the virtual communication modifier client 402 recognizes the key combination and determines that the virtual communication will be textual. A different key combination may indicate that the virtual communication will be audio. The virtual communication modifier client 402 can record the spoken words as audio signals within an audio file. The virtual communication modifier client 402 can then process the audio signals, such as with the assistance of the virtual communication modifier server 418, using language recognition software or devices. The virtual communication modifier client 402 can also store any text inputs from the keyboard 412 in a text file within the memory of the computer 410 and analyze the text using language recognition software. The virtual communication modifier client 402, and/or the virtual communication modifier server 418, may utilize other software or devices to detect other characteristics of the audio signals (e.g., voice speed, dialect, tone) or text (e.g., formality of language). In some examples, the avatar 408 may utilize a virtual universe item in conjunction with a virtual communication, such as item 409. The text 414 on the item 409 could be written in a specific language, such as English, with currency symbols representative of United States dollars. The virtual communication modifier client 402 can determine a language for the text 414 by querying the VU server 428 for a default language for the item 409. For example, the item 409 may have a record entry in the database 430 which contains settings, values, etc. regarding the item 409. One of the settings or values could include the default language for the text 414 displayed on the item 409.

The flow 300 continues at processing block 306, where the virtual communication modifier system determines whether the communication is directed specifically at one avatar. In FIG. 4 at stage “3”, the avatar 408 speaks the virtual communication in talk bubble 415 and the virtual communication modifier client 402 attempts to detect any indicators by the avatar 408 that indicate whether the virtual communication is intended for the single avatar 407, or for a group of avatars. For example, the virtual communication modifier system 400 detects whether the avatar 408 follows a VU protocol for selecting an avatar 407 before speaking to the avatar 407. If no such protocol has been detected, for instance, the virtual communication modifier system 400 determines that the communication is not directed specifically at one avatar. Consequently, referring back to FIG. 3, the process would continue at block 308. Otherwise, if the virtual communication modifier system determines that communication is directed specifically at one avatar, the process would continue at block 312.

The flow 300 continues at processing block 308, where the virtual communication modifier system analyzes communication indicators. In FIG. 4 at stage “4”, the virtual communication modifier system 400 analyzes communication indicators that indicate to which avatars the virtual communication is directed. Some indicators include, but are not limited to, a direction of an avatar's view, gestures made by an avatar, an affinity or relationship of the avatar to another avatar, a distance between avatars, virtual universe settings and protocols regarding communication between avatars in the virtual universe, etc. For instance, the virtual communication modifier client 402 could detect a virtual distance between the speaking avatar 408 and the nearest avatar 407. Virtual distances can be geographic or Euclidean distances between avatar 408 and any other object in the VU. Virtual distances can be measured and set according to rules within the VU that dictate communication ranges for both visual and audible communications.

The flow 300 continues at processing block 310, where the virtual communication modifier system determines a communication area based on the communication indicators. In FIG. 4, still referring to stage “4”, the virtual communication modifier system 400 determines a boundary 413, which emcompasses an area of the VU surrounding the communicating avatar 408. The area emcompassed by the boundary 413 represents an “earshot” distance within the VU, determined by VU rules or set by user preferences, indicating a set communication range for a spoken communication of the avatar 408. Any avatars within the spoken communication boundary 413 can see the talk bubble 415 inside of the VU. For instance, computer 410 renders the VU rendering area 401 to present the talk bubble 415. Other avatars, like avatar 419, outside of the boundary 413, would not see the talk bubble 415. The VU, however, may still have different rules regarding items, such as item 409. Although the avatar 419 may be outside of the avatar's spoken communication boundary 413, the avatar 419 may still be able to see the item 409, which may be contained within a larger boundary for viewable communications, like text on an item 409.

The flow 300 continues at processing block 312, where the virtual communication modifier system determines the language preference of user accounts for avatars to whom the communication is directed. In FIG. 4 at stage “5”, the virtual communication modifier system 400 determines a preferred language of the avatar to whom the virtual communication is directed. For example, the avatar 408 is communicating with avatar 407, and, thus, the virtual communication modifier system 400 queries the database 430 to find a database entry 432 pertaining to avatar 407 that includes a column 434 for the preferred language of the avatar 407. The virtual communication modifier system 400 determines from the database entry 432 that avatar 407 has a preferred language of Spanish. The avatar 407 may have a ranked list of preferred languages.

The flow 300 continues at processing block 314, where the virtual communication modifier system determines whether the language indicated in the user preference is different from the actual language value of the communication. In FIG. 4, still at stage “5”, the virtual communication modifier system 400 compares the language value (i.e. “English”) of the virtual communication from talk bubble 415 in VU rendering area 401 and determines that is it different from the preferred language value (i.e. Spanish) shown in column 434 for avatar 407. If the languages values were the same, the processes would have continued at block 318. However, because the languages values were different, the process continues at block 316.

The flow 300 continues at processing block 316, where the virtual communication modifier system translates the virtual communication to the language value indicated in the user preference. In FIG. 4 at stage “6”, the virtual communication modifier server 418 automatically performs a conversion process that copies the text contents of the talk bubble 415 from English to Spanish. The virtual communication modifier server 418 stores the converted text in temporary memory as the process continues. Likewise, the virtual communication modifier server 418 could convert the text on the item 409 into Spanish and store the converted text in memory. If the virtual communication is audio based, then the virtual communication modifier server 418 can convert an audio file of the virtual communication from spoken English into an audio file of spoken Spanish.

The flow 300 continues at processing block 318, where the virtual communication modifier system determines whether communication modification preferences are specified in the user account. In FIG. 4 at stage “7”, the virtual communication modifier system 400 queries the database 430 to determine whether the user account for avatar 407 includes preferences related to other communication characteristics that can be modified. Other modifiable characteristics include a language dialect, voice speed, voice tone, formality of language, text type or size, etc., for all of which the database entry 432 may have a set preference. For example, the user associated with avatar 408 may communicate using the headset 442 to generate a spoken virtual communication. The spoken communication, however, may be very fast, as the user may speak very fast. The virtual communication modifier server 418, however, can analyze the speech pattern of the spoken communication and compare it to the preferred voice speed indicated in database entry 432. The database entry 432 indicates that avatar 407 has a preference to receive slow speech communications via the VU. If communication modification preferences are specified, then the process continues at block 320. If communication modification preferences are not specified, then the process continues at block 322.

The flow 300 continues at processing block 320, where the virtual communication modifier system modifies the virtual communication based on the communication preferences. In FIG. 4 at stage “8”, the virtual communication modifier server 418 processes the additional preferences. For example, the virtual communication modifier server 418 can slow a speed playback for a spoken virtual communication. The virtual communication modifier server 418 can slow voice speed, for instance, by recording the time from a first clock 460 associated with the computer 410 to determine a duration for the audio file associated with the spoken virtual communication. The virtual communication modifier server 418 can then reference a second clock 462 associated with the computer 411. During playback of the audio file, the virtual communication modifier server 418 can slow processing of the audio file measured by the second clock 462 to generate a slow playback speed for the audio file.

The flow 300 continues at processing block 322, where the virtual communication modifier system determines whether a preferred communication format is indicated in the user account preferences and if the preferred communication format is different from the format of the virtual communication. A communication format includes the structure of the communication, such as whether it contains text components, audio components, special visual components besides text, musical components, electronic enhancement or variations, etc. In FIG. 4, at stage “9”, the virtual communication modifier server 418 looks for a preferred format preference in the database entry 432. The database entry 432 includes a preferred format for avatar 407. For instance, avatar 407 prefers textual communications over voice communications. The virtual communication modifier system 400 can convert voice to text or text to voice depending on the user account preference. If the preferred format is different than the format of the virtual communication, then the process continues at block 324. If the preferred format is not different from the format of the virtual communication, then the process continues at block 326.

The flow 300 continues at processing block 324, where the virtual communication modifier system converts the virtual communication to the preferred communication format. In FIG. 4 at stage “10”, the virtual communication modifier server 418 converts any audio elements of the virtual communication from talk bubble 415 into text.

The flow 300 continues at processing block 326, where the virtual communication modifier system presents the virtual communication in the virtual universe according to the preferences in the user account. If the preferences have indicated differences in language, format, or other modifiable characteristics, then the virtual communication modification system presents the virtual communication in a modified format, either with a language conversion, a format conversion, some other modification, or any combination thereof. In FIG. 4 at stage “11”, the virtual communication modifier system 400 presents the modified virtual communications to the avatar 407 in the VU rendering area 403 as seen by avatar 407 via computer 411. The talk bubble 415 in the VU rendering area 403 includes text in Spanish. If the communication was spoken, and the user account for avatar 407 had other preferences, like voice speed variation, then the virtual communication modifier server 418 passes the modified voice file to the virtual communication modifier client 404 to present the modified voice file through the speaker 441. The virtual communication modifier system 400 also presents text 414 associated with item 409 in a converted format. As shown in VU rendering area 403, the text 414 is in Spanish. The textual design on the dress reads “NENA”, which is a Spanish word for “GIRL”. The virtual communication modifier system 400 can also convert text 414 on the tag for the item 409 from one currency format into another. For example, if the user account for avatar 407 includes a preference for currency presentation (e.g., Euros instead of US dollars), then the virtual communication modifier server 418 can convert the currency symbols and make numerical conversions for currency, to present a different currency symbol in the VU rendering area 403. If the avatar 407 conducts a business transaction, such as passing an amount of virtual currency 480 to the avatar 408, then the virtual communication modifier server 418 can also perform currency conversions and present the amount to the avatar 408, in VU rendering area 403, in preferred currency symbols. The VU rendering area 401, as seen by avatar 408, simultaneously presents all information in English, the preferred language preference for the user account associated with avatar 408. The avatar 407 can respond with virtual communications as well, such as talk bubble 416. The user associated with avatar 407 may utilize the keyboard 413 or other means to converse, (e.g., avatar 407 converses in Spanish using computer 411). The virtual communication modifier system 400 detects the response communication from the avatar 407 then performs the flow 300 for the virtual communications by avatar 407 to automatically modify the virtual communications and present them to avatar 408 in the VU rendering area 401 (e.g., the avatar 408 sees the talk bubble 416 in English). The flow 300 can be performed for multiple avatars at a time. For example, the virtual communication modifier system 400 could present the same virtual communication from avatar 408 to multiple avatars, not just 407. The virtual communication modifier system 400 would read the user account preferences for all of the avatars to ensure that all avatars receive the virtual communications according to their preferences.

In some embodiments, the virtual communication modifier system 400 can make preferences accessible to other avatars or entities. For instance, the virtual communication modifier system 400 can provide visible tags that indicate an avatar's preferences, such as a preferred language. For example, avatar 407 has a visible tag 472 that indicates the preferred languages in order of preference (e.g., SP/EN for “Spanish/English”). The virtual communication modifier system 400 can read the preferences from data in the database entry 432 that pertains to the avatar 407. The avatar 408 can see the visible tag 472 within the VU rendering area 401. The avatar 408 also has a visible tag 470 that indicates the preferred languages for avatar 408. The avatar 407 can see the visible tag 470 within the VU rendering area 403. The virtual communication modifier system 400 can also make preferences accessible via search or query capabilities. User accounts can include settings that indicate what preferences can be accessed so that avatars can specify the accessibility of the characteristics (e.g. private versus public, blocked versus viewable, etc.).

In some embodiments, a virtual communication modifier system can receive feedback from an avatar, user, etc. (“communication recipient”) who has received a modified communication. The communication recipient can indicate whether the communication was automatically modified correctly or to the recipient's liking. The virtual communication modifier system can automatically make the indicated corrections and update a user profile and preferences accordingly. For example, the virtual communication modifier system can translate a language to a specific language, but the communication recipient may indicate that the specific language is no longer a preferred language, or that for the communication session, the language is inappropriate. The virtual communication modifier system may offer one or more options to make a correction (e.g., present a list of other preferred languages in the recipient's user profile, present a list of other languages being spoken in a room, present a comment box to enter instructions, etc.) In some embodiments, the virtual communication modifier system can also provide a mechanism for a user to train or teach the virtual communication modifier system (e.g., correct mistranslations, correct voice pronunciations, correct dialect or coded languages, etc.) After receiving feedback, the virtual communication modifier system can learn from the feedback and make corrections during the session (e.g., override previous preferences as indicated by recipient, translate in a newly specified language by recipient, etc.) and in the system (e.g., update a user profile with the proper languages, format, etc. as indicated by the recipient, learn proper translations, etc.)

In some embodiments, the operations described in FIG. 3 and FIG. 4 can be performed in series, while in other embodiments, one or more of the operations can be performed in parallel. For example the blocks 314 through 324 can be performed in different order than those described.

Referring now to FIG. 4, in some embodiments, the virtual communication modifier system 400 modifies communications received from outside the VU and presents them in the VU. For example, a user could utilize a telephone 448, via a telephone system (e.g., wireless, land line, VOIP, etc.). The virtual communication modifier system 400 can receive communications from the telephone 448 and present them within the VU rendering area 401 or 403. The virtual communication modifier system 400 can also modify the communications from the telephone 448 by converting languages, converting voice to text, modifying voice or text characteristics, etc. in the same way that the virtual communication modifier system 400 modified communications for intra-VU communications. The virtual communication modifier system 400 can read from user account preferences, like those in database entry 432, to modify the communications from the telephone 448. Alternatively, the virtual communication modifier system 400 can process virtual communications from the VU and present them outside of the VU. For example, the virtual communication modifier system 400 can modify the contents of talk bubble 415 and send the information to the telephone 448. The virtual communication modifier system 400 can modify the content of the talk bubble 415 by converting text to voice, and sending a voice signal through the telephone 448 so that an audible voice is presented on the telephone 448. Further, the virtual communication modifier system 400 can store contact information and preferences for others outside of the VU who wouldn't have a user account in the VU. The preferences could include preferred languages, communication formats and characteristics for the extra-VU parties. The virtual communication modifier system 400 can present communications from inside the virtual universe and outside the virtual universe in a group setting, such as a conference call, wherein some group participants provide communications from inside the VU and others provide communications outside of the VU.

In some embodiments, the virtual communication modifier system 400 permits queries to the database 430 so that avatars can ascertain an other avatar's preferred method of communication. For example, avatar 408 may query the database 430 and determine that avatar 407 prefers communications in Spanish. Consequently, the avatar 408 may prefer to communicate originally in Spanish, to avoid any potential translation errors or delays.

In some embodiments, the virtual communication modifier system 400 can determine a common language for groups of avatars. For instance, several avatars may be gathered together for a meeting, a social gathering, or other event. The virtual communication modifier system 400 may detect which language is common among all, or most, of the event participants and broadcast the virtual communications of the event in the common language.

In some embodiments, the virtual communication modifier system 400 can detect and utilize constructed or artificial languages (e.g., lingo, slang, combined dialects, coded speech, group speak, abbreviated speech, etc.). For example, a couple of avatars may indicate that a conversation should be translated to a lingo that only some avatars may understand, such as “web chat” lingo. The virtual communication modifier system 400 therefore converts the conversation into the artificial language. The virtual communication modifier system 400 can convert the conversation into the artificial language, even though the conversing avatars may be actually conversing in a non-artificial, or natural, language. This is especially beneficial for group scenarios where a group of people may understand a specific artificial language and wish to isolate the group of speakers in the VU to provide a level of group security or establish a semi-private group setting.

In some embodiments, the virtual communication modifier system 400 can automatically detect and add languages to the user account preferences when the system discovers that an avatar understands or uses a language that isn't already in the user account preferences. Further, the virtual communication modifier system 400 can include other user preferences not listed above, such as a time to use automatic modification services, a location to use automatic modification services, a threshold distance between avatars to indicate communication ranges and other preferences, such as that a user can understand a language when written, but not when spoken.

### Additional Example Operating Environments

This section describes example operating environments, systems and networks, and presents structural aspects of some embodiments.

### Example Virtual Communication Modifier Network

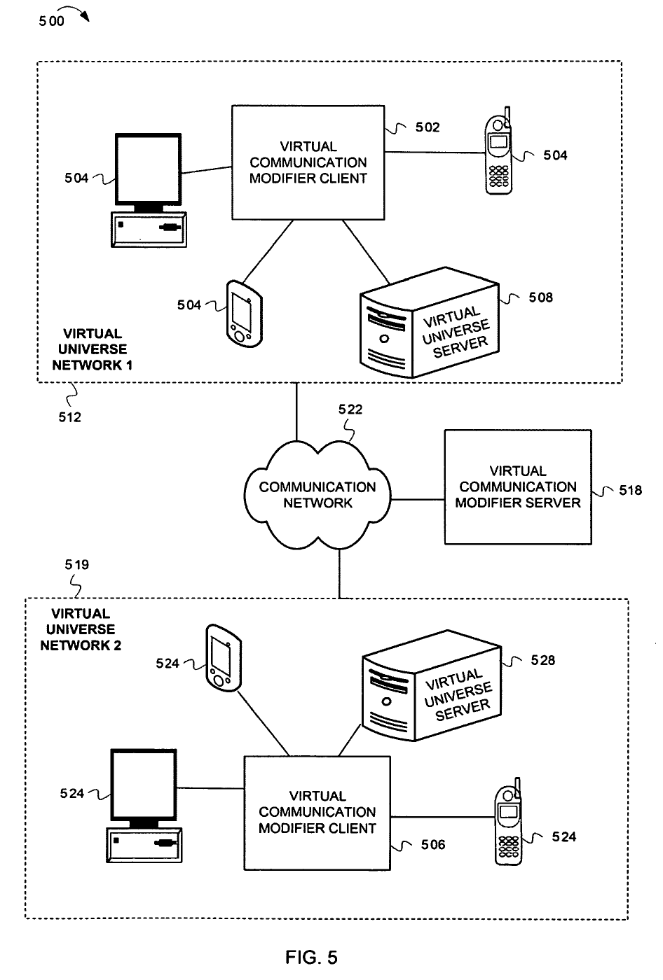

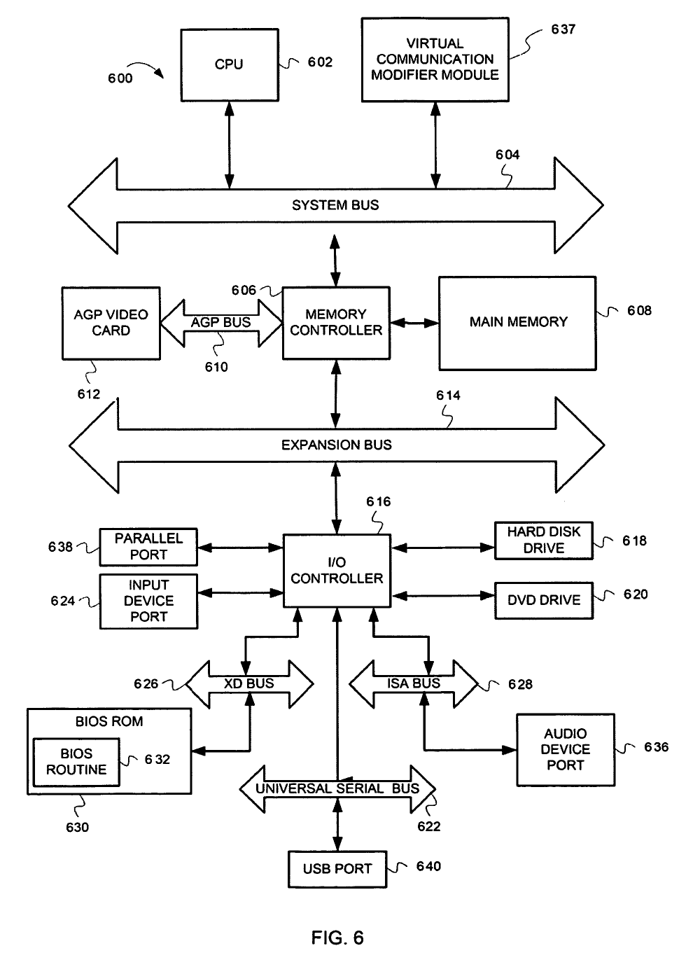

FIG. 5 is an illustration of an example virtual communication modifier network 500. In FIG. 5, the virtual communication modifier network 500, includes a first virtual universe local network (“local network”) 512 that includes network devices 504 and 508 that can use a virtual communication modifier client 502. Example network devices 504 and 508 can include personal computers, personal digital assistants, mobile telephones, mainframes, minicomputers, laptops, servers, or the like. In FIG. 5, some network devices 504 can be client devices (“clients”) that can work in conjunction with a server device 508 (“server”). Any one of the network clients 504 and server 508 can be embodied as the computer system described in FIG. 6. A communications network 522 connects a second local network 519 to the first local network 512. The second local network 519 also includes clients 524 and a server 528 that can use a virtual communication modifier client 506.

Still referring to FIG. 5, the communications network 522 can be a local area network (LAN) or a wide area network (WAN). The communications network 522 can include any suitable technology, such as Public Switched Telephone Network (PSTN), Ethernet, 802.11g, SONET, etc. A virtual communication modifier server 518 is also connected to the communications network 522. The virtual communication modifier server 518 facilitates communication between virtual universes. For instance, avatars, users, etc. from the virtual universe served by virtual universe server 508 can converse with avatars in the virtual universe served by virtual universe server 528. The virtual communication modifier server 518 works in conjunction with the local networks 512, 519, to automatically modify communications between the avatars, users, etc. from the different virtual universes.

In some embodiments, a communication could flow from the virtual communication modifier client 502, in the first local network 512, through the communication network 522 to the virtual communication modifier client 506. The virtual communication modifier client 506 can detects that the communication is in a language that is different from a non-preferred language for the geographic region where the client is located, or that the communication is in a language different from a default language for the geographic region. If no servers within the second local network 519 include capabilities for translation or other modification, the virtual communication modifier client 506 could forward the communication to another server not in the second local network 519, such as the virtual communication modifier server 518 or to a third party server, for translation.

For simplicity, the virtual communication modifier network 500 shows only eight clients 504, 524, 502, 506, and three servers 508, 528, 518 connected to the communications network 522. In practice, there may be a different number of clients and servers. Also, in some instances, a device may perform the functions of both a client and a server. Additionally, the clients 504, 524, 502, 506, can connect to the communications network 522 and exchange data with other devices in their respective networks 512, 519 or other networks (not shown). In addition, the virtual communication modifier clients 502 and 506 may not be standalone devices or modules. For example, the virtual communication modifier client 502 may be distributed across multiple machines, perhaps including the server 508. The virtual communication modifier client 502 may be embodied as hardware, software, or a combination of hardware and software in a server, such as the server 508. One or both of the virtual communication modifier clients 502 and 506 may also be embodied in one or more client machines, possibly including one or more of the clients 504 and 524.

### Example Virtual Communication Modifier Computer System

FIG. 6 is an illustration of an example virtual communication modifier computer system 600. In FIG. 6, the virtual communication modifier computer system 600 (“computer system”) includes a CPU 602 connected to a system bus 604. The system bus 604 is connected to a memory controller 606 (also called a north bridge), which is connected to a main memory unit 608, AGP bus 610 and AGP video card 612. The main memory unit 608 can include any suitable memory random access memory (RAM), such as synchronous dynamic RAM, extended data output RAM, etc.

In one embodiment, the computer system 600 includes a virtual communication modifier module 637. The virtual communication modifier module 637 can process communications, commands, or other information, to automatically detect and modify communications in a virtual universe. The virtual communication modifier module 637 is shown connected to the system bus 604, however the virtual communication modifier module 637 could be connected to a different bus or device within the computer system 600. The virtual communication modifier module 637 can include software modules that utilize main memory 608. For instance, the virtual communication modifier module 637 can wholly or partially be embodied as a program product in the main memory 608. The virtual communication modifier module 637 can be embodied as logic in the CPU 602 and/or a co-processor, one of multiple cores in the CPU 602, etc.

An expansion bus 614 connects the memory controller 606 to an input/output (I/O) controller 616 (also called a south bridge). According to embodiments, the expansion bus 614 can be include a peripheral component interconnect (PCI) bus, PCIX bus, PC Card bus, CardBus bus, InfiniBand bus, or an industry standard architecture (ISA) bus, etc.

The I/O controller is connected to a hard disk drive (HDD) 618, digital versatile disk (DVD) 620, input device ports 624 (e.g., keyboard port, mouse port, and joystick port), parallel port 638, and a universal serial bus (USB) 622. The USB 622 is connected to a USB port 640. The I/O controller 616 is also connected to an XD bus 626 and an ISA bus 628. The ISA bus 628 is connected to an audio device port 636, while the XD bus 626 is connected to BIOS read only memory (ROM) 630.

In some embodiments, the computer system 600 can include additional peripheral devices and/or more than one of each component shown in FIG. 6. For example, in some embodiments, the computer system 600 can include multiple external multiple CPUs 602. In some embodiments, any of the components can be integrated or subdivided.

Any component of the computer system 600 can be implemented as hardware, firmware, and/or machine-readable media including instructions for performing the operations described herein.

The described embodiments may be provided as a computer program product, or software, that may include a machine-readable medium having stored thereon instructions, which may be used to program a computer system (or other electronic device(s)) to perform a process according to embodiments of the invention(s), whether presently described or not, because every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Although some examples refer to communications that transmit text or voice, other forms of communication may be used, like streaming media (e.g. streaming voice or video), chats, music, etc. Various devices and communication protocols not mentioned can also be utilized, like touch based communications (e.g., Braille devices), satellite transmissions, graphical images that represent text, cartoon depictions, etc. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments, which are defined only by the appended claims. Each of the embodiments described herein are contemplated as falling within the inventive subject matter, which is set forth in the following claims.

1. A method comprising:
determining whether a first characteristic of a communication differs from a second characteristic specified as a preferred communication characteristic of an avatar, said communication to be presented to the avatar in a virtual universe;
automatically modifying the communication in accordance with the second characteristic resulting in a modified communication; and
presenting the modified communication to the avatar.

2. The method of claim 1, wherein the modifying comprises converting the communication between an audio format and a text format.

3. The method of claim 1, wherein the communication originates from an inanimate object in the virtual universe.

4. The method of claim 1, further comprising:
determining that the communication is for presentation to a plurality of avatars including the avatar;
automatically determining a language most commonly indicated by the plurality of avatars as a preferred language; and
modifying the communication to be presented in the language that is most commonly indicated.

5. The method of claim 1, wherein the modifying comprises modifying any one or more of a voice speed and a voice tone of the communication.

6. The method of claim 1, wherein the modifying comprises translating from a first language to a second language.

7. The method of claim 1, wherein the modifying comprises converting the communication between a natural language and an artificial language

8. The method of claim 1, further comprising making the first indicated characteristic accessible to one or more other avatars in the virtual universe.

9. The method of claim 1, further comprising modifying the communication for presentation outside of the virtual universe.

10. The method of claim 1, further comprising:
determining a second actual characteristic of the communication is different than a second indicated characteristic;
automatically modifying the communication in accordance with the second indicated characteristic; and
presenting the modified communication to the avatar with both the first indicated characteristic and second indicated characteristic.

11. An apparatus, comprising:
a communication characteristic detector configured to detect a communication for presentation to an avatar in a virtual universe,
a characteristic comparator configured to determine that an actual characteristic of the communication is different than an indicated characteristic for communications to be presented to the avatar in the virtual universe;
a communication characteristic modifier configured to automatically modify the communication in accordance with the indicated characteristic to generate a modified communication; and
a communication content presenter configured to present the modified communication to the avatar.

12. The apparatus of claim 11, further comprising a communication indication processor configured to analyze one or more communication indicators that indicate that the communication is directed to the avatar.

13. The apparatus of claim 11, wherein the communication characteristic modifier comprises a language converter configured to automatically modify a language characteristic of the communication to match a language value indicated in a user account.

14. The apparatus of claim 11, wherein the communication characteristic modifier comprises a format converter to convert the communication between an audio format and a text format.

15. The apparatus of claim 11, wherein the communication characteristic modifier comprises a sound modulator to modify any one or more of a voice speed or a voice tone of the communication.

16. One or more machine-readable media having instructions stored thereon, which when executed by a set of one or more processors causes the set of one or more processors to perform operations that comprise:
detecting a communication for presentation to an avatar in a virtual universe;
determining that a first actual characteristic of the communication is different than a first indicated characteristic for communications to be presented to the avatar in the virtual universe;
automatically modifying the communication in accordance with the first indicated characteristic to generate a modified communication; and
presenting the modified communication to the avatar.

17. The machine-readable media of claim 16, wherein the operations for automatically modifying the communication comprise translating from a first language to a second language.

18. The machine-readable media of claim 16, wherein the operations for automatically modifying the communication comprise converting the communication between an audio format and a text format.

19. The machine-readable media of claim 16, wherein the characteristic comprises any one or more of a dialect, a format, a voice speed, a voice tone, a formality of language, a text font and a text size.

20. The machine-readable media of claim 16, wherein the operations further comprise determining that the communication is for presentation to a plurality of avatars including the avatar, determining one or more communication characteristics indicated for the plurality of avatars, and modifying the communication for the plurality of avatars.
